(19) United States
(12) Patent Application Publication
(10) Pub. No.: US 2025/0203699 A1
(43) Pub. Date: Jun. 19, 2025

(54) RECEIVING TRANSMISSIONS FROM DIFFERENT CELLS

(71) Applicant: Nokia Technologies Oy, Espoo (FI)

(72) Inventors: Ugur Baran ELMALI, Munich (DE); Faranaz SABOURI-SICHANI, Aalborg (DK); Bighnaraj PANIGRAHI, Bangalore (IN)

(21) Appl. No.: 18/846,452

(22) PCT Filed: Jul. 3, 2023
(86) PCT No.: PCT/FI2023/050422

§ 371 Date: Sep. 12, 2024

(30) Foreign Application Priority Data
Aug. 8, 2022 (IN) 202241045222

(51) Int. Cl. H04W 76/27; H04W 72/1263

(52) U.S. Cl. CPC H04W 76/27; H04W 72/1263

(57) ABSTRACT

There is provided a method at a user equipment, comprising: receiving information of transmission schedule from a second cell, wherein the apparatus is capable of receiving from one cell at a time; determining, based on the received transmission schedule, that transmissions from the second cell cannot be received within limits set by a gap configuration of a first cell, wherein the apparatus is in radio resource control (RRC) connected state with respect to the first cell; transmitting to the second cell an indication that the transmissions from the second cell cannot be received based on the transmission schedule; and receiving information of a modified transmission schedule from the second cell.

### TECHNICAL FIELD

Various example embodiments relate generally to receiving transmissions from different cells.

### BACKGROUND

There are occasions where a user equipment (UE) would need to listen to transmissions (e.g. broadcast and unicast) from different cells. However, it may be that the UE has limitations regarding capabilities to receiving multiple transmissions simultaneously. For example, a UE with limited hardware and software resources, e.g single receiver (RX) and single transmitter (TX) chains, may nevertheless be expected to receive broadcast messages from one cell, while it may have unicast communication with same or another network simultaneously from another cell. Solutions are needed for enabling the UE to receive both transmissions.

### BRIEF DESCRIPTION

According to some aspects, there is provided the subject matter of the independent claims. Some further aspects are defined in the dependent claims.

### LIST OF THE DRAWINGS

In the following, the invention will be described in greater detail with reference to the embodiments and the accompanying drawings, in which

FIG. 1 presents a network, according to an embodiment;

FIG. 2 shows an example of MCCH transmission, according to an embodiment;

FIGS. 3 and 4 show methods, according to some embodiments;

FIGS. 5A, 5B and 6 show signaling flow diagrams, according to some embodiments;

FIGS. 7 to 10 show different options for modifying the transmission schedule, according to some embodiments; and

FIGS. 11 and 12 illustrate apparatuses, according to some embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. For the purposes of the present disclosure, the phrases “at least one of A or B”, “at least one of A and B”, “A and/or B” means (A), (B), or (A and B). For the purposes of the present disclosure, the phrases “A or B” and “A and/or B” means (A), (B), or (A and B). For the purposes of the present disclosure, the phrase “A, B, and/or C” means (A), (B), (C), (A and B), (A and C), (B and C), or (A, B, and C).

Embodiments described may be implemented in a radio system, such as one comprising at least one of the following radio access technologies (RATs): Worldwide Interoperability for Micro-wave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), Long Term Evolution (LTE), LTE-Advanced, and enhanced LTE (eLTE). Term ‘eLTE’ here denotes the LTE evolution that connects to a 5G core. LTE is also known as evolved UMTS terrestrial radio access (EUTRA) or as evolved UMTS terrestrial radio access network (EUTRAN). A term “resource” may refer to radio resources, such as a physical resource block (PRB), a radio frame, a subframe, a time slot, a subband, a frequency region, a sub-carrier, a beam, etc. The term “transmission” and/or “reception” may refer to wirelessly transmitting and/or receiving via a wireless propagation channel on radio resources

The embodiments are not, however, restricted to the systems/RATs given as an example but a person skilled in the art may apply the solution to other communication systems provided with necessary properties. One example of a suitable communications system is the 5G system. The 3GPP solution to 5G is referred to as New Radio (NR). 5G has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G may require bringing the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customised to meet the specific needs of applications, services, devices, customers or operators.

In radio communications, node operations may in be carried out, at least partly, in a central/centralized unit, CU, (e.g. server, host or node) operationally coupled to distributed unit, DU, (e.g. a radio head/node). It is also possible that node operations will be distributed among a plurality of servers, nodes or hosts. It should also be understood that the distribution of labour between core network operations and base station operations may vary depending on implementation. Thus, 5G networks architecture may be based on a so-called CU-DU split. One gNB-CU controls several gNB-DUs. The term ‘gNB’ may correspond in 5G to the eNB in LTE. The gNBs (one or more) may communicate with one or more UEs. The gNB-CU (central node) may control a plurality of spatially separated gNB-DUs, acting at least as transmit/receive (Tx/Rx) nodes. In some embodiments, however, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers. Other functional splits are possible too. It is considered that skilled person is familiar with the OSI model and the functionalities within each layer.

In an embodiment, the server or CU may generate a virtual network through which the server communicates with the radio node. In general, virtual networking may involve a process of combining hardware and software network resources and network functionality into a single, software-based administrative entity, a virtual network. Such virtual network may provide flexible distribution of operations between the server and the radio head/node. In practice, any digital signal processing task may be performed in either the CU or the DU and the boundary where the responsibility is shifted between the CU and the DU may be selected according to implementation.

Some other technology advancements probably to be used are Software-Defined Networking (SDN), Big Data, and all-IP, to mention only a few nonlimiting examples. For example, network slicing may be a form of virtual network architecture using the same principles behind software defined networking (SDN) and network functions virtualisation (NFV) in fixed networks. SDN and NFV may deliver greater network flexibility by allowing traditional network architectures to be partitioned into virtual elements that can be linked (also through software). Network slicing allows multiple virtual networks to be created on top of a common shared physical infrastructure. The virtual networks are then customised to meet the specific needs of applications, services, devices, customers or operators.

The plurality of gNBs (access points/nodes), each comprising the CU and one or more DUs, may be connected to each other via the Xn interface over which the gNBs may negotiate. The gNBs may also be connected over next generation (NG) interfaces to a 5G core network (5GC), which may be a 5G equivalent for the core network of LTE. Such 5G CU-DU split architecture may be implemented using cloud/server so that the CU having higher layers locates in the cloud and the DU is closer to or comprises actual radio and antenna unit. There are similar plans ongoing for LTE/LTE-A/eLTE as well. When both eLTE and 5G will use similar architecture in a same cloud hardware (HW), the next step may be to combine software (SW) so that one common SW controls both radio access networks/technologies (RAN/RAT). This may allow then new ways to control radio resources of both RANs. Furthermore, it may be possible to have configurations where the full protocol stack is controlled by the same HW and handled by the same radio unit as the CU.

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future rail-way/maritime/aeronautical communications. Satellite communication may utilize geostationary earth orbit (GEO) satellite systems, but also low earth orbit (LEO) satellite systems, in particular mega-constellations (systems in which hundreds of (nano) satellites are deployed). Each satellite in the mega-constellation may cover several satellite-enabled network entities that create on-ground cells. The on-ground cells may be created through an on-ground relay node or by a gNB located on-ground or in a satellite.

The embodiments may be also applicable to narrowband (NB) Internet-of-things (IoT) systems which may enable a wide range of devices and services to be connected using cellular telecommunications bands. NB-IoT is a narrowband radio technology designed for the Internet of Things (IoT) and is one of technologies standardized by the 3rd Generation Partnership Project (3GPP). Other 3GPP IoT technologies also suitable to implement the embodiments include machine type communication (MTC) and eMTC (enhanced Machine-Type Communication). NB-IoT focuses specifically on low cost, long battery life, and enabling a large number of connected devices. The NB-IoT technology is deployed “in-band” in spectrum allocated to Long Term Evolution (LTE)-using resource blocks within a normal LTE carrier, or in the unused resource blocks within a LTE carrier's guard-band—or “standalone” for deployments in dedicated spectrum.

The embodiments may be also applicable to device-to-device (D2D), machine-to-machine, peer-to-peer (P2P) communications. The embodiments may be also applicable to vehicle-to-vehicle (V2V), vehicle-to-infrastructure (V2I), infrastructure-to-vehicle (12V), or in general to V2X or X2V communications.

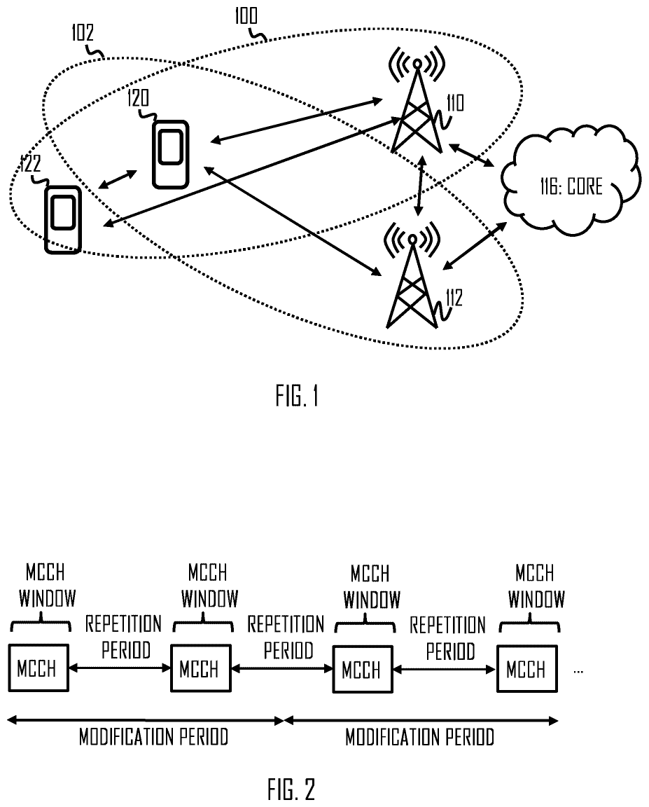

FIG. 1 illustrates an example of a communication system to which embodiments of the invention may be applied. The system may comprise a control node 110 providing one or more cells, such as cell 100, and a control node 112 providing one or more other cells, such as cell 102. Each cell may be, e.g., a macro cell, a micro cell, femto, or a pico cell, for example. In another point of view, the cell may define a coverage area or a service area of the corresponding access node. The control node 110, 112 may be an evolved Node B (eNB) as in the LTE and LTE-A, ng-eNB as in eLTE, gNB of 5G, or any other apparatus capable of controlling radio communication and managing radio resources within a cell. The control node 110, 112 may be called a base station, network node, or an access node.

The system may be a cellular communication system composed of a radio access network of access nodes, each controlling a respective cell or cells. The access node 110 may provide user equipment (UE) 120 (one or more UEs) with wireless access to other networks such as the Internet. The wireless access may comprise downlink (DL) communication from the control node to the UE 120 and uplink (UL) communication from the UE 120 to the control node.

Additionally, although not shown, one or more local area access nodes may be arranged such that a cell provided by the local area access node at least partially overlaps the cell of the access node 110 and/or 112. The local area access node may provide wireless access within a sub-cell. Examples of the sub-cell may include a micro, pico and/or femto cell. Typically, the sub-cell provides a hot spot within a macro cell. The operation of the local area access node may be controlled by an access node under whose control area the sub-cell is provided. In general, the control node for the small cell may be likewise called a base station, network node, or an access node.

There may be a plurality of UEs 120, 122 in the system. Each of them may be served by the same or by different control nodes 110, 112. The UEs 120, 122 may communicate with each other, in case D2D communication interface is established between them.

The term “terminal device” or “UE” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

In the case of multiple access nodes in the communication network, the access nodes may be connected to each other with an interface. LTE specifications call such an interface as X2 interface. For IEEE 802.11 network (i.e. wireless local area network, WLAN, WiFi), a similar interface Xw may be provided between access points. An interface between an eLTE access point and a 5G access point, or between two 5G access points may be called Xn. Other communication methods between the access nodes may also be possible. The access nodes 110 and 112 may be further connected via another interface to a core network 116 of the cellular communication system. The LTE specifications specify the core network as an evolved packet core (EPC), and the core network may comprise a mobility management entity (MME) and a gateway node. The MME may handle mobility of terminal devices in a tracking area encompassing a plurality of cells and handle signalling connections between the terminal devices and the core network. The gateway node may handle data routing in the core network and to/from the terminal devices. The 5G specifications specify the core network as a 5G core (5GC), and there the core network may comprise e.g. an access and mobility management function (AMF) and a user plane function/gateway (UPF), to mention only a few. The AMF may handle termination of non-access stratum (NAS) signalling, NAS ciphering & integrity protection, registration management, connection management, mobility management, access authentication and authorization, security context management. The UPF node may support packet routing & forwarding, packet inspection and QoS handling, for example.

As said above, a UE may be required to receive both unicast and MBS broadcast simultaneously from different cells (e.g. unicast from a first cell and multicast and broadcast services (MBS) from a second cell) of either the same or different networks/operators. The UE may share its hardware and software resources between those broadcast and unicast receptions, which may in turn lead to limitations in unicast transmission/reception for UEs with limited hardware and software resources, e.g. receive and transmit chains. In case of different operators. e.g., UE receives unicast from one cell and broadcast from another cell from another network, UEs may use multiple SIMs (MUSIMs), one for each operator. For example, cell 100 of FIG. 1 may be provided by one operator, where cell 102 is provided by another operator.

Considering the MBS as the required transmission from the second cell, Rel-17 MBS work item has specified broadcast reception for the UEs that can be in IDLE/INACTIVE/CONNECTED radio resource control (RRC) states. In order for the UE to receive the MBS broadcast in the RRC_IDLE/RRC_INACTIVE mode:
System information block (SIB) 20 includes the information required for the UE to receive the Multicast Control Channel (MCCH) information including the repetition period and configured transmission/reception/monitoring window of MCCH.
MCCH information is transmitted periodically by a gNB using a configurable repetition period and within a configured transmission window (also known as reception or monitoring window, or as MCCH window). The MCCH information is control information for the UE to understand which broadcast services are provided in the cell and the scheduling information to receive the broadcasted data. For example, MCCH provides information about the Multicast Traffic Channels (MTCHs), i.e. data channels where the broadcast services are provided. This information includes search spaces, discontinuous reception (DRX) information, etc. for the UE to be able to receive the relevant MTCH(s). Each Temporary Multicast Group Identifier (TMGI), which is an identifier of a specific broadcast service, is mapped to a specific MTCH.
The UE reads and decodes the SIB20 message and learns the MCCH configuration/scheduling details. Then the UE reads the MCCH to learn about which services are provided in the cell and their scheduling information.

For the UEs in RRC_CONNECTED mode, SIB reading may be bypassed, as the UE is provided with the search space configuration to receive MCCH within PDCCH_ConfigCommon.

When receiving transmissions from different operators, the UE may be MUSIM capable. A multi-SIM work item in Rel-17 focused on providing support of MUSIM operation for a single RX/single TX or dual RX/single TX devices. Due to the limited UE capability, the supported scenarios are cases where the UE can be in RRC_IDLE or RRC_INACTIVE state in one cell, and in RRC_CONNECTED, RRC_INACTIVE, or RRC_IDLE in another cell. An enhanced mobile broadband (eMBB) device may have several receiver (RX) and transmitter (TX) chains to be able to support higher bandwidths (carrier aggregation (CA)/dual-connectivity (DC) scenarios). However, even if the hardware capability would allow parallel MUSIM operation, i.e., UE being RRC_CONNECTED in 2 different cells, majority of current devices do not allow this due to hardware (HW) and software (SW) design complexity (including implementation of two parallel basebands, protocol stacks, and coordination), and/or complex verification. Hence in general, single SW architecture is applied.

This may cause problems as a MUSIM UE with single RX cannot perform RRC_IDLE/INACTIVE operations in one network, while in RRC_CONNECTED with another network, simultaneously, i.e., reception of any data at the same time from different cells is not possible. For example, one possible problematic scenario can be to monitor paging from one network, while in RRC_CONNECTED state with another network, simultaneously. Further, a MUSIM UE with a single RX chain cannot monitor paging on more than one network, simultaneously.

As solutions to these problematic cases, Rel-17 have specified, e.g., the following:
The UE can request and receive periodic or aperiodic gaps to the cell where the UE is in RRC_CONNECTED state, e.g., for paging, measurements, etc., to be performed on the cell where the UE is in RRC_IDLE/RRC_INACTIVE. The maximum periodic/aperiodic gap duration of Rel-17 may be limited to 20 ms.
The UE may leave the current RRC_CONNECTED cell (and go to RRC_IDLE), if it decides to move to RRC_CONNECTED with the other network. Compared to Rel-16, the UE can go to RRC_IDLE autonomously, without network configuration, after it has requested the network to release the RRC connection after a (pre-) configured wait time. In this case the Network is aware that the UE leaves, as the UE may notify this using RRC Assistance Information (using e.g. RRC UEAssistanceInformation message). If the network releases the UE by RRC release it can consider the indicated UE preference about d RRC state after the RRC connection is released.
If the UE is paged in the cell where it is in RRC_INACTIVE/RRC_IDLE, but decides not to respond to the paging, the UE can send a BUSY indication to the network.
A paging cause (voice/not voice) is added to the paging message, so that UE can decide whether it should leave/release the connection with network where the UE is originally in RRC_CONNECTED and connect to the other network where it is originally in RRC_INACTIVE/RRC_IDLE.

However, further problems may arise with specific type of transmission from the second cell, e.g. the MBS. FIG. 2 illustrates MCCH transmission/repetition operation in a cell based on Rel-17 MBS. MCCH information (Physical downlink control channel, PDCCH, and following Physical downlink shared channel, PDSCH, scrambled via MCCH-RNTI) is transmitted by the gNB in MCCH windows every “repetition period” that are configured in SIB20 and monitored by the UE. During this window, the UE attempts to blind decode for MCCH-RNTI. The very same information is repeated during a modification period, i.e., the MCCH information transmitted by the gNB does not change during this period. The MCCH information may change in the next modification period, e.g., when a broadcast service starts/ends etc. This may be indicated by a change notification in PDCCH scheduling MCCH. Based on current standard specifications, MCCH window duration can be [2-160] slots.

Moreover, using the MCCH information, for each MTCH (mapped to one or several broadcast services), the UE can be configured with a DRX cycle, in which the UE needs to wake up and try to decode for the actual broadcast data transmissions (PDCCH and the following PDSCH scrambled via G-RNTI). Based on current standard specifications, DRX on duration per G-RNTI can be [1-1600] ms.

Therefore, to receive the broadcast services in RRC_IDLE/RRC_INACTIVE state (provided via the second cell), the UE may need to periodically monitor information in MCCH, in addition to monitoring for the data itself within DRX cycles per G-RNTI. Assuming the maximum tolerable gap in an RRC connection will be similar to the maximum periodic/aperiodic gap duration agreed for MUSIM operation, musim-GAPLength of Rel-17, the gap length would be limited to 20 ms. Therefore, a UE may only expect gap in its DL/UL scheduling without leaving the RRC connection from the first cell and monitor any MCCH/MTCH in the second cell within the duration of 20 ms, which may not be enough in practical scenarios considering MCCH monitoring/MTCH monitoring per G-RNTI. Leaving the RRC connection in the first cell for each MCCH would be inefficient. Allowing longer gaps with the expected MCCH window length for MBS operation will result in an unacceptable performance degrade in on-going RRC connection.

Measurement gaps or scheduling gaps are opportunities given to the UE to perform measurements on downlink signals. This is because a UE may not be able to perform inter-frequency or inter-RAT measurements/monitoring while also transmitting or receiving with another, connected cell. Even for intra-frequency measurements, a 5G UE may require measurement gaps if such measurements are to be performed outside the UE's currently active Bandwidth Part (BWP). The network (e.g. the connected cell) configures the UE with measurement gaps via RRC signalling. The network configures these gaps such that they do not coincide with UE transmissions or receptions from the connected cell. The gap configuration, defining e.g. measurement gap repetition period, MGRP (if periodic), gap offset (specifies starting subframe) and measurement gap length, may be changed later upon UE's request or by the network. A UE may be configured with multiple measurement gaps, or the UE may apply autonomous gaps. UE's RRC layer typically informs Layer 1 about the gaps. Layer 1 obeys these gaps for making measurements, for monitoring other cell's transmissions, etc. The entire measurement gap is usually not used for measurements. A UE requires some time for retuning its RF transceivers. Hence, actual measurement duration may be smaller than the measurement gap length.

Thus, one issue is that the network does not know whether a broadcast session is received by a UE, as any UE in a geographical area (e.g. cell 102) authorized by the network node 112 to receive data can receive broadcast service. Therefore, a cell does not know whether all the UEs are able to decode e.g. MCCH, etc., properly, as there is no feedback mechanism. Thus, the gNB 112 may freely determine how large MCCH window will be and how DRX cycle is scheduled per G-RNTI. If those do not fit to the maximum gap the UE can take from another network (or any other UE limitation), the UE may have problems receiving the transmission from the second cell 102.

To address these problems, there is proposed a solution for the UE and the gNB, so that the UE, that is expected to receive one transmission (e.g. broadcast services, MBS) from the second cell while it may have unicast communication with the same or another network simultaneously from the first cell, can receive the MBS transmissions. Assumption is that the UE has limitation (e.g. a single RX chain, or otherwise limited hardware and software resources) that does not allow the UE to receive simultaneously from two networks. Hence, a UE can receive transmissions at most from one cell at a time. Although a UE that is a MUSIM UE in RRC_CONNECTED state in one network corresponding to its first SIM (e.g. the first cell 100 from a first operator) and in RRC_IDLE/RRC_INACTIVE state in another network corresponding to its second SIM (e.g. the second cell 102 from a second operator) is used as an example, it is noted that the problem and the proposed solution apply to any scenario where a UE is expected to concurrently receive MBS broadcast from one cell and unicast transmissions from another cell (with same or different operator).

It is noted that RRC_CONNECTED, RRC CONNECTED and RRC connected are used interchangeably in the description and figures. Similarly, RRC_IDLE, RRC IDLE and RRC idle are used interchangeably, as well as RRC_INACTIVE, RRC INACTIVE and RRC inactive.

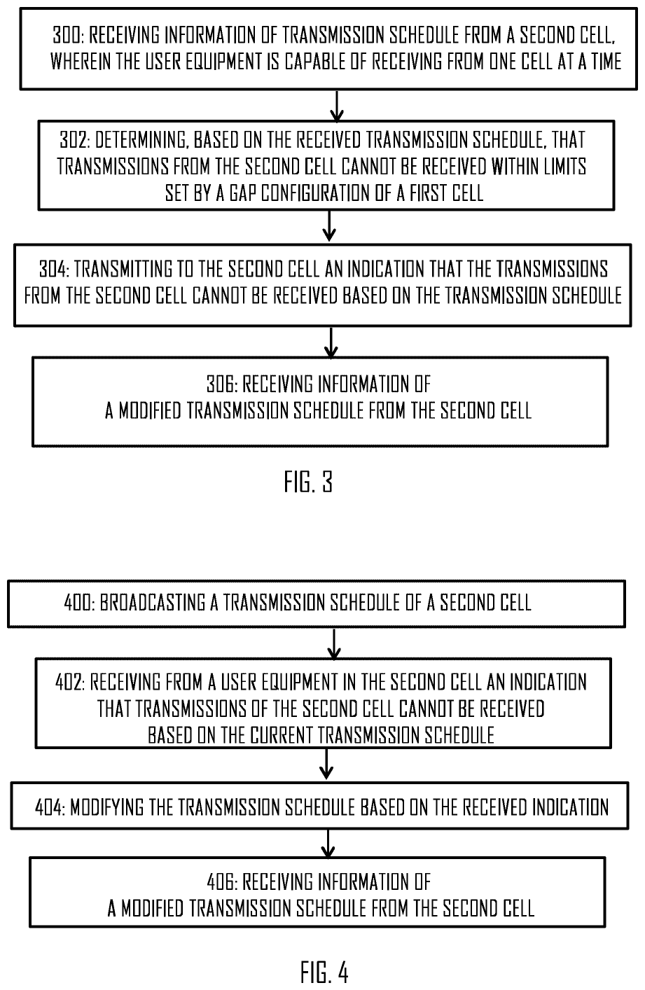

FIG. 3 depicts an example method. The method may be computer-implemented. The method may be performed by a user equipment, such as the UE 120 of FIG. 1.

Accordingly, as shown in FIG. 3, the UE 120 may in step 300 receive information of transmission schedule from the second cell, wherein the apparatus is capable of receiving from one cell at a time. Here it is considered that the gNB 112 is a network node of the second cell, while gNB 110 is a network node of the first cell to which the UE is currently connected to or performs communication with. The gNB 112 of the second cell 102 may be responsible for transmitting the transmission schedule of the second cell.

In an embodiment, the transmission may be MBS transmission from the second cell 102 but is not limited to MBS. The transmission schedule may be read from e.g. SIB20 and/or MCCH sent by the gNB 112, in which case, the transmission schedule may indicate a broadcast transmission schedule. In case the transmission schedule is obtained from SIB20, the transmission schedule may indicate the schedule of MCCH transmissions. In case the transmission schedule is obtained from MCCH, the transmission schedule may indicate the schedule of MTCH transmissions. In case the transmission schedule is obtained from SIB20 and MCCH, the transmission schedule may indicate the schedule of MCCH and MTCH transmissions. Further, the information of the transmission schedule may be received by the UE 120 via a broadcast transmission from the second cell 102. This can take place while the UE 120 is in RRC IDLE state, or in RRC inactive state, with respect to the second cell 102.

In an embodiment, the transmission schedule comprises at least one of periodicity, transmission length, or modification length of control channel information of the broadcast transmission (e.g. MCCH) associated with the transmission schedule (indicated e.g. in SIB 20).

In step 302, the UE 120 determines, based on the received transmission schedule, that a transmission from the second cell 102 cannot be received within limits set by a gap configuration of the first cell 100. The apparatus may be in RRC connected state with respect to the first cell 100. The gap configuration, or a single gap for monitoring the other cell, may have been received from the gNB 110 of the first cell 100, possibly upon request by the UE 120.

In an embodiment, the reception of the information of the transmission schedule in step 500 triggers the UE 120 to request for the gap configuration of the first cell. Gap configuration may define one or more gaps of the first cell when the gNB 110 may not schedule communication with the UE 120.

In an embodiment, it may be that the MCCH window (e.g. the transmission monitoring window for the transmissions of the second cell 102) is larger than a defined gap length (or larger than maximum available gap of the first cell 102), or the repetition periods of MCCH and periodic gaps do not match, for example.

In step 304, the UE 120 transmits to the second cell 102 (e.g. to the gNB 112) an indication that transmissions from the second cell 102 cannot be received based on the current transmission schedule. In an embodiment, the indication may comprise information of the gap configuration of the first cell 102. In an embodiment, the indication may comprise at least one of the following: the maximum gap duration that the UE 120 can request from the first cell 100 or the maximum transmission monitoring window (e.g. MCCH window) that the UE 120 can tolerate from the second cell 102.

In step 306, the UE 120 receives information of a modified transmission schedule from the second cell 102. This modification may be based on the indication of step 304. The gNB 112 of the second cell may perform the modification, so that the UE 120 can receive the transmission (e.g. MBS) from the second cell 102 within the gaps of the first cell 100.

FIG. 4 depicts an example method. The method may be computer-implemented. The method may be performed by a network node (e.g. gNB 112) of the second cell 102.

The gNB 112 in step 400 broadcasts the transmission schedule of the second cell 102. As said, in an embodiment, this can include the broadcast of MCCH and/or SIB20, for example.

In step 402, the gNB 102 receives from the UE 120 in the second cell 102 an indication that transmissions of the second cell cannot be received based on the current transmission schedule. The indication may comprise information of e.g. the gap configuration of the first cell 100 and/or the maximum transmission monitoring window the UE 120 can tolerate from the second cell 102.

Based on this indication, the gNB 102 in step 404 modifies the transmission schedule. The modified transmission schedule may enable the UE 120 to receive the transmissions (e.g. MBS) from the second cell 102 within the limits set by the gap configuration of the first cell 100.

In an embodiment, modifying the transmission schedule based on the received indication comprises reducing the maximum transmission monitoring window (e.g. MCCH) associated with the transmissions of the transmission schedule, or reducing the window(s) for receiving MTCH(s) from the cell 110. For example, if the maximum available gap length from the first cell 100 is 20 ms and the current MCCH monitoring window is 40 ms, the length of the MCCH monitoring window may be reduced to 20 ms.

In an embodiment, modifying the transmission schedule based on the received indication comprises partitioning the transmissions of the transmission schedule. This may be combined with transmitting, to the UEs in the cell, different transmission schedules for the different partitions.

In yet one embodiment, modifying the transmission schedule based on the received indication comprises rearranging the content of the transmissions of the transmission schedule such that predetermined type of content is transmitted in the beginning of a respective transmission window. For example, assume the MCCH has a length of 40 ms. Based on the rearranging, the most important data (based on a predetermined criteria) is transmitted in the beginning of the MCCH, so that the UE 120 with e.g. 20 ms gap can receive the first half of the MCCH.

In an embodiment, the gNB 112 receives, in step 402, a plurality of indications from a plurality of user equipments in the cell 112, and, in step 404, modifies the transmission schedule based on the received plurality of indications. The gNB 112 may apply thresholds when deciding whether to perform modifications and in deciding what type of modifications to perform to the transmission schedule. For example, when there are several UEs in cell 112 without problems of receiving MBS of cell 112, and one or only a few (i.e. less than a predetermined threshold) UEs report preference of different transmission schedule, the gNB 112 may refrain from performing modifications. In yet one embodiment, when several UEs request modification of the transmission schedule, the gNB 112 may decide to apply the modification, and modify the transmission schedule based on an indication from a UE that has most severe limitations, for example. That is, the gNB 112 can schedule based on the UE with the most limitations, e.g., scheduling MCCH window based on smallest possible maximum MCCH monitoring window reported or smallest possible maximum DRX on duration UE can tolerate for the data. In one embodiment, even one indication to adjust the transmission schedule triggers the modification. In an embodiment, the gNB 112 can decide to ignore some UEs' limitations, in case network does not think that, e.g., reported maximum DRX on duration is enough to deliver the data.

In step 406 the gNB 102 broadcasts the modified transmission schedule of the second cell 102. Similarly to the transmission of step 400, this broadcast may be receivable by UEs within the second cell 102. As a result, the UEs in the cell 102 become aware of the modified transmission schedule of the cell 102.

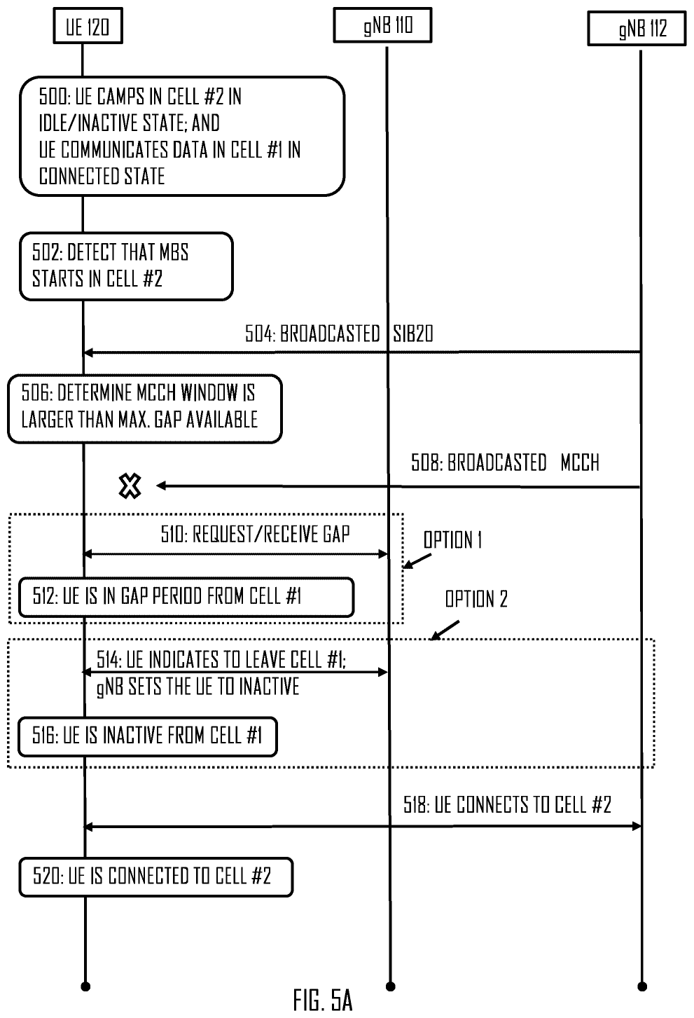

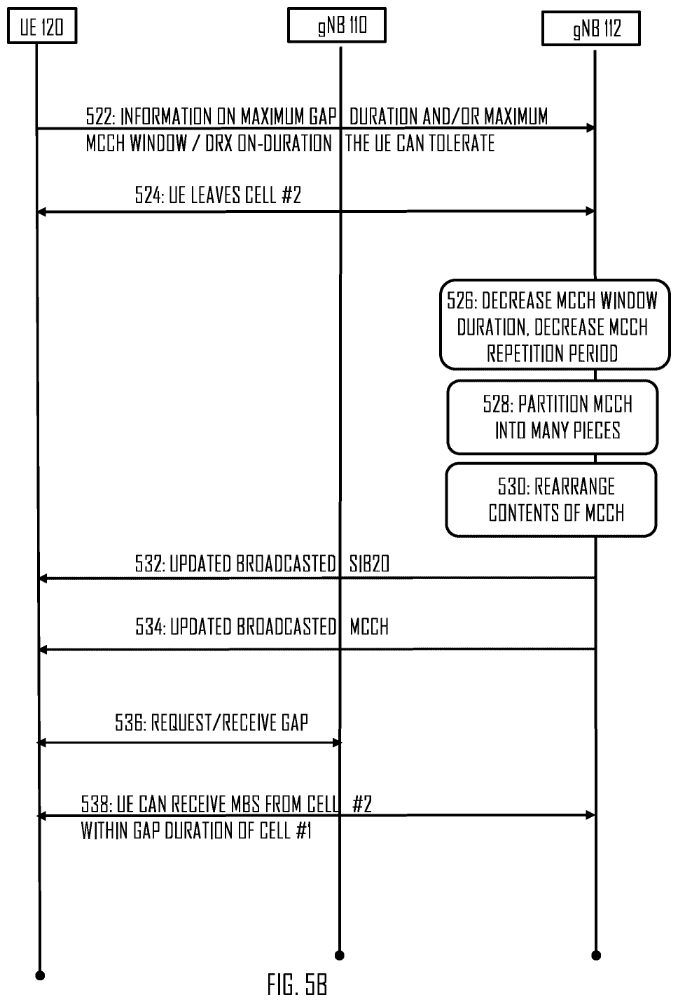

FIGS. 5A and 5B show a signaling flow diagram between the UE 120, gNB 100 of the first cell 100 (also referred to as cell #1) and gNB 110 of the second cell 102 (also referred to as cell #2). In step 500, the UE 120 camps in cell #2 in RRC idle or RRC inactive state. The UE 120 is in RRC connected state with cell #1. It is assumed that currently there is no broadcast service ongoing/started that the UE 120 has interest in cell #2, or the UE 120 is outside the service area of a service that the UE 120 is interested in. It is noted that the UEs may be preconfigured with information on the service area of broadcast services using service announcement, which may be in the form of NAS signalling.

In step 502, the UE detects that MBS starts in cell #2. The MBS is used as an example, and the interested transmissions from cell #2 can be any transmissions, e.g. unicast, multicast or broadcast. As alternative to detecting the MBS service starting in cell #2, the UE 120 may in an embodiment reselect a cell (e.g. cell #3) that broadcasts the service that the UE 120 has interest, or the UE 120 becomes interested in a service that is provided in cell #2.

In step 504, the UE 120 reads transmission schedule (e.g. in SIB20) of cell #2 (or cell #3 in case UE reselected cell #3 in step 502). The reading of the SIB 20 may be done during a gap from cell #1. In another example reading of the SIB 20, and possibly at least one MCCH, may be done by leaving RRC connection in cell #1. Based on obtained transmission schedule, the UE 120 becomes aware of requirements needed from the UE 120 to receive the service from cell #2 (or cell #3).

Based on the knowledge of the transmission schedule of interested transmissions of cell #2, the UE 120 in step 506 determines that MCCH in step 508 (and/or MTCH, if MCCH is listened) for the broadcast service from cell #2 cannot be monitored due to maximum gap duration limitation (e.g., DRX on duration for that G-RNTI>maximum gap duration and/or MCCH monitoring window is higher than the maximum gap duration). Step 508 comprising the broadcasted MCCH may comprise repeatedly sent messages, as shown in FIG. 2.

In an embodiment (not shown in FIG. 5A), the UE monitors SIB 20 and detects that MCCH can be listened. However, based on reception of the MCCH, the UE may determine that interested MTCH(s) cannot be received properly within the gaps available. In such case, the UE needs to request modification of the transmission schedule of the MTCHs from the second cell.

In one option (first option 1 in FIG. 5A), in step 510, the UE 120 may transmit a gap request to request for a gap, possibly with maximum possible length (e.g. 20 ms) to cell #1. In an embodiment, wherein the UE 120 is a MUSIM UE, MUSIM periodic or aperiodic gap are available for any operation required by UE's other USIM including MBS related use. The UE 120 may then receive gap configuration from cell #1. In an embodiment, this gap is a single aperiodic gap. In step 512, it is assumed that the UE 120 is in a gap period from cell #1.

In another option shown with steps 514 to 516 and labelled as option 2, as an alternative to steps 510-512 (labelled as option 1 in FIG. 5A), the UE 120 decides to leave its RRC connection with cell #1 to make use of the full MCCH window of cell #2 (or cell #3), assuming the MCCH could not be received within the gap duration. In this case, since the UE 120 will return to cell #1 after the MCCH window of cell #2 is over, it may be beneficial not to move to RRC_IDLE with respect to cell #1 but to enter RRC inactive state which allows the UE's fast return to cell #1. To achieve this, the UE 120 may send in step 514 UE assistance information (UEAssistanceInformation) for RRC leave with preference to move to RRC inactive. The entering RRC inactive (or even RRC idle) with respect to cell #1 may be used e.g. when following steps 518 to 522 cannot be completed within the maximum gap duration of cell #1. As said, if the UE is moved to RRC inactive, the UE 120 can beneficially apply RRC resume to quickly resume in RRC connected with cell #1.

The UE 120 can in step 518 connect with the second cell #2, after which the UE is in step 520 RRC connected with cell #2. It is noted that when the UE 120 is in gap, as shown in step 512 or when it has released RRC connection from cell 1, as in steps 514 and 516, the UE 120 can establish RRC connection to cell #2 in step 518/520 (if gap time allows). That is both options 1 and 2 may include connecting to the cell #2 in step 518/520 while it may still be in RRC_CONNECTED in cell #1 (option 1, within the gap) or RRC_INACTIVE in cell #1 (option 2).

That is, in one embodiment, the UE 120 can establish connection to the second cell in step 518 and leave the second cell in step 524 within a gap of cell #1, without leaving the RRC connected state with cell #1. While in another embodiment, the gap period is not seen sufficiently long, in which case the UE may leave cell #1, establish connection with cell #2 (steps 518-520) and then in step 524 leave the leave the second cell and resume (in case the UE is RRC inactive with respect to cell #1) or re-establish connection (in case the UE is RRC idle with respect to cell #1) with the first cell #1. In one further embodiment, the UE may utilize small data transmissions without entering RRC connected state with cell #2 (i.e. without performing steps 518, 520 and 524), as will be explained later.

In an embodiment, the UE 120 leaves the RRC connection of cell #1 and moves to RRC idle autonomously, e.g. after a configured time after it has requested to leave RRC connection in cell #1 if it has not received RRC release message from cell #1. In yet one embodiment, the UE 120 is moved to RRC inactive by the gNB 110 (e.g. RRC release with a suspend configuration) as response to UE's request to release RRC connection with preference to move to RRC inactive. It is noted that (not shown in FIG. 5) that cell #1 may decide to release UEs RRC connection without suspend configuration.

In step 522, the UE 120 sends information on the limitation on the maximum gap duration to cell #2 (or cell #3, if that is the cell with which the UE connected to in previous steps). This information can be signalled together with Multicast Interest Indication (MII) defined in Rel-17 that includes the information at which services the UE is interested in. The information can include e.g. the maximum gap duration that the UE 120 can have from the other operator/cell #1 and/or maximum MCCH monitoring window/DRX on duration that the UE 120 can tolerate from cell #2.

As indicated above, in an embodiment, step 522 can be performed by using SDT while staying connected to cell #1 and without entering in RRC connected state with respect to cell #2. In another embodiment, step 522 can be performed after connecting to second cell #2, while either staying connected to cell #1 or after releasing the connection to cell #1.

In step 524, after sending the modification request in step 522, the UE may 120 release the connection to cell #2 to enter RRC idle or inactive with respect to cell #2. Thus, the UE 120 temporarily entered RRC connected state with respect to the second cell #2 and transmitted the information to the second cell #2 in the RRC connected state. Here, in an embodiment, a UE initiated RRC release may be used. Step 524 may also comprise the UE re-establishing or resuming the previous connection with cell #1, if it has left the RRC connection in cell #1.

Steps 526, 528 and 530 show a few nonlimiting embodiments on how the gNB 112 may then modify the transmission schedule, to enable the UE 120 in cell #2 to monitor the interested service (e.g. the MBS) from cell #2 within the gap configuration of cell #1. That is, based on the information received in step 522 (possibly sent by multiple UEs in cell #2), optimizations can be made at cell #2, so that the UEs that are interested in the transmitted broadcast service shall be able to receive the service of interest. The gNB 112 may perform one or more of the steps 526, 528 and 530.

In the option of step 526, if the gNB 112 has configured larger MCCH transmission window and/or DRX on-periods than the indicated maximum gap(s) of cell #1, those can be set to smaller values that would fit the limitations of the UE(s). This is shown in FIG. 7. This embodiment may become relevant because typically the aforementioned transmission periods may be set by the respective gNB 112 to large values in order to be flexible, e.g., MCCH can be transmitted at a time where the gNB sees fit based on the load in the cell within the MCCH transmission window.

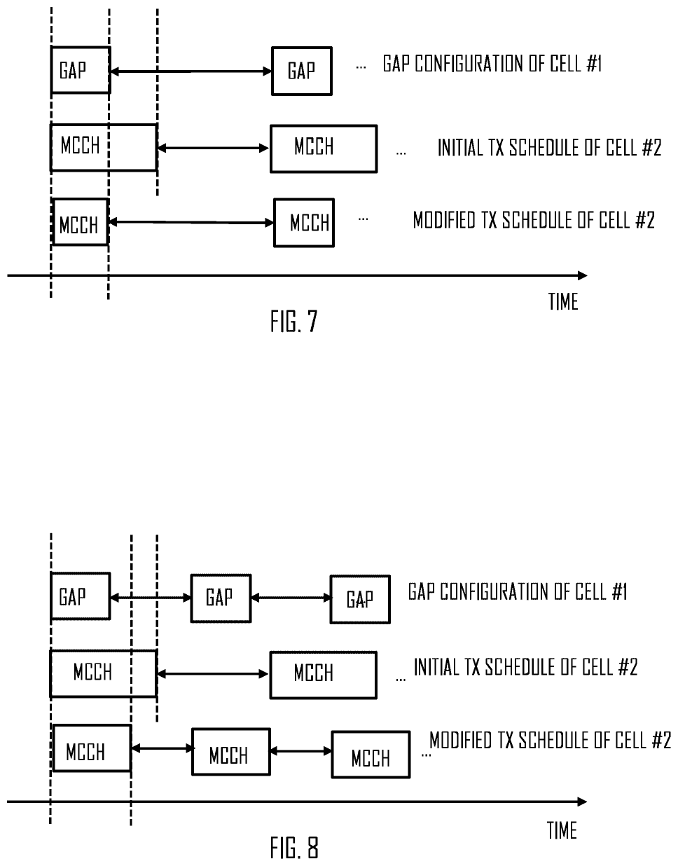

By reducing the duration(s), this flexibility may be compromised with the upside that more UEs are enabled to receive the interested service from cell #2. However, if the gNB 112 is not willing to compromise this flexibility so much that it would meet the needs of the UE 120, then, as an alternative, MCCH repetition period can be shortened, as shown in FIG. 8, while still possibly configuring the MCCH window duration smaller (even if not still fully fitting the within the gap period).

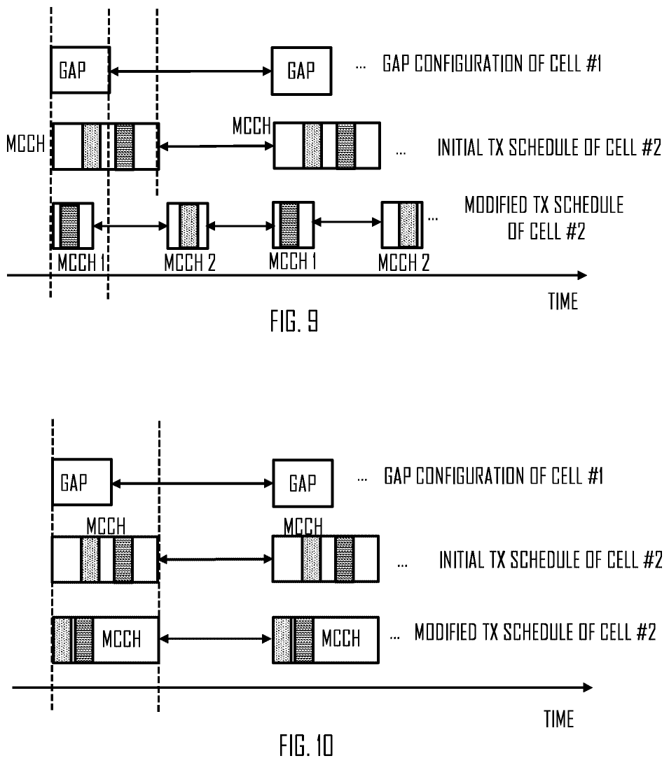

In the option of step 528 of FIG. 5B, the gNB 112 may partition, as shown in FIG. 9, the MCCH information into several pieces and transmit the relevant parts for such UEs in a feasible transmission window duration. The part(s) of MCCH information that the UE is interested in, e.g., scheduling information of the broadcast service that the UE is interested in marked with block with horizontal lines inside the MCCH, would then be transmitted using configurations suitable for the UE's maximum gap. This may allow the UEs with limitation(s) to receive relevant parts of the message. The other, not-interested, service, marked with block having dots, can be transmitted even in locations not receivable by the UE 120. In this case, SIB20 may be enhanced, so that different transmission schedule (e.g. MCCH scheduling information) shall be provided for each of the different pieces of the partitioned MCCH. In an embodiment, other information of MCCH (e.g., scheduling information for other broadcast services) are kept unchanged.

In the option of step 530, the gNB 112 rearranges the content of the transmissions from cell #2 such that predetermined type of content is transmitted in the beginning of the transmission window. For example, assume the MCCH has a length of 40 ms. Based on the rearranging, the most important data (based on a predetermined criteria) is transmitted in the beginning of the MCCH, so that the UE 120 with e.g. 20 ms gap can receive the first half of the MCCH. This is shown in FIG. 10, where the blocks with dots and horizontal lines within the MCCH block represent the predetermined content that is seen as important for the UE to receive. As shown, these block with dots and horizontal lines are rearranged to take place in the first half of the MCCH block that fits inside the configured gap of cell #1. As another example, if UE's broadcast data is scheduled at say after 30 ms (out of 40 ms), then the gNB 112 may adjust the transmission schedule again to bring it to the front part (within 20 ms) and hence resend the changes in SIB20.

In steps 532 and/or 534, the gNB 112 then transmits the modified transmission schedule to the UEs cell #2. This may take place with SIB20 and/or MCCH, depending on which transmissions (MCCH and/or MTCH) is/are adjusted, for example. The UE 120 may detect those during a requested gap of cell #1 (can be a single aperiodic gap) or during being connected to cell #2.

As indicated above, the option 1 shown in FIG. 5A comprises an embodiment which does not require connection to the second cell #2. In this embodiment the steps requiring the UE 120 to disconnect from cell #1 and connect to cell #2 are not needed (i.e. steps 514-520 and 524 may be omitted). In this embodiment, if the UE 120 is in RRC inactive (or RRC idle) state with cell #2 during the gap 512, the UE 120 need not necessarily setup RRC connection with cell #2 to transmit the information about its limitation(s). Instead. the UE 120 may beneficially apply small data transmission (SDT) to send this information as SDT payload as the information is expected to fit to the allowed payload size for SDT. This may comprise the UE 120 to use random access procedure wherein Message 3 or message A in 4-step or 2-step random access procedure may carry the SDT. In this option, the transmission of the limitation of step 522 can take place during the gap period mentioned in step 512.

The UE 120 may then determine, based on reception of the modified transmission schedule, that the interested transmissions (e.g. MBS) from cell #2 can be received within the limits set by the gap configuration of cell #1. This may be enabled e.g. because now the MCCH monitoring window or MTCH(s) fits within the possible gap it the UE 120 can request from cell #1 (e.g. maximum gap duration configured) from cell #1. Consequently, the UE 120 may in step 536 request a gap according to the new MBS configuration and receive the corresponding configuration from cell #1 (that is, if the UE 120 has not yet at this point received suitable gap configuration from the gNB 110). The UE 120 in step 538 may receive MBS from cell #2 while staying RRC connected to cell #1.

The solutions of FIGS. 5A/5B may provide several advantages. For example, UEs with HW/SW limitations that are to receive both unicast and MBS broadcast simultaneously from different cells of either the same or different networks/operators can request modifications of the broadcast transmissions, such that the network can optimize the broadcast configuration to fit the UEs' limitations.

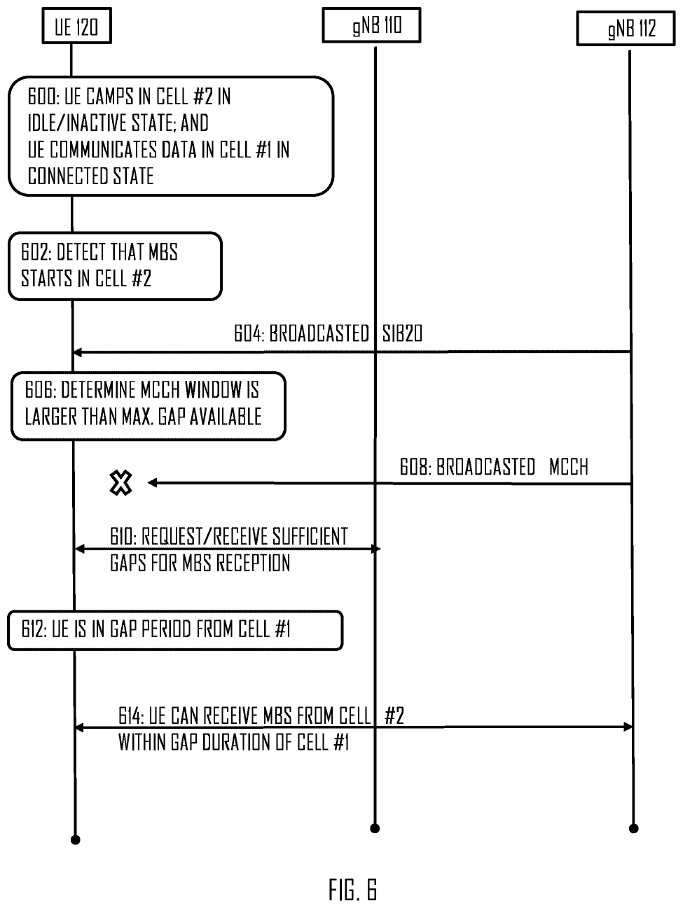

Another solution to the discussed problems is presented in FIG. 6. Steps 600-608 are the same as steps 500-508. However, in this embodiment of FIG. 6, MBS specific gaps are introduced, so that the UE 120 is able to request, in step 610, for such larger gaps from cell #1 to receive broadcast from cell #2 during the gap duration. For this, assistance Information (e.g. the request of step 610 to cell #1) can be enhanced to include also a reason, e.g., broadcast reception from other cell, in addition to the requested gap duration. In step 612, the UE is in gap duration from cell #1. During this gap, which is assumed to be longer than the default gaps allocated to the UE in the embodiment of FIGS. 5A/5B, the UE 120 is in step 614 able to receive the broadcast transmission from cell #2.

This embodiment of FIG. 6 may allow the UEs with HW/SW limitations that are to receive both unicast and MBS broadcast simultaneously from different cells of either the same or different networks/operators can request larger gap durations from the RRC connected state cell, in order to receive broadcast service from another cell in RRC idle/inactive mode.

In FIGS. 5 and 6, it is assumed that the MCCH is not receivable by the UE 120 within the allocated gaps from cell #1. However, MCCH is merely an example, and it could be e.g. MTCH reception that is problematic, or some other type of transmission whose transmission schedule consequently needs adjustments (FIG. 5A/5B) or why longer gaps are needed (FIG. 6).

An embodiment, as shown in FIG. 11, provides an apparatus 10 comprising a control circuitry (CTRL) 12, such as at least one processor, and at least one memory 14 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 10 may comprise the terminal device of a communication system, e.g. a user terminal (UT), a computer (PC), a laptop, a tabloid computer, a cellular phone, a mobile phone, a communicator, a smart phone, a palm computer, a mobile transportation apparatus (such as a car), a household appliance, or any other communication apparatus, commonly called as UE in the description. Alternatively, the apparatus is comprised in such a terminal device. Further, the apparatus may be or comprise a module (to be attached to the UE) providing connectivity, such as a plug-in unit, an “USB dongle”, or any other kind of unit. The unit may be installed either inside the UE or attached to the UE with a connector or even wirelessly.

In an embodiment, the apparatus 10 is or is comprised in the UE 120. The apparatus may be caused to execute some of the functionalities of the above described processes, such as the steps of FIG. 3.

The apparatus may further comprise a radio interface (TRX) 16 comprising hardware and/or software for realizing communication connectivity according to one or more communication protocols. The TRX may provide the apparatus with communication capabilities to access the radio access network, for example.

The apparatus may also comprise a user interface 18 comprising, for example, at least one keypad, a microphone, a touch display, a display, a speaker, etc. The user interface may be used to control the apparatus by the user.

The control circuitry 12 may comprise a communication control circuitry 20 for determining what is the required transmission schedule of the transmissions from the second cell, and for requesting modifications to the transmission schedule, as needed, according to any of the embodiments. The control circuitry 12 may further comprise a gap determination circuitry 22 for determining the configured gaps of the first cell, and for determining whether the transmissions of the second cell can be received during the gap periods of the first cell, according to any of the embodiments.

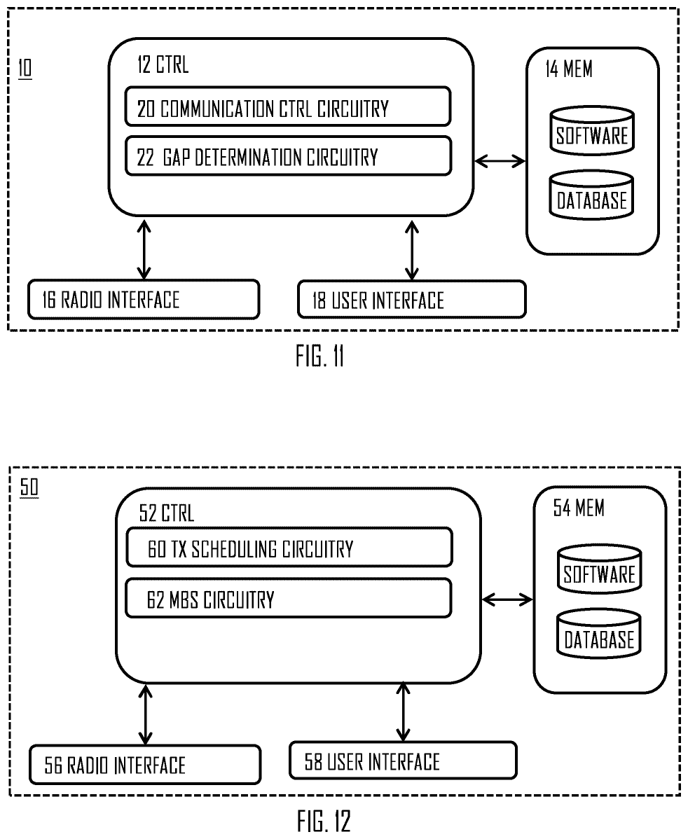

An embodiment, as shown in FIG. 12, provides an apparatus 50 comprising a control circuitry (CTRL) 52, such as at least one processor, and at least one memory 54 storing instructions that, when executed by the at least one processor, cause the apparatus at least to carry out any one of the above-described processes. In an example, the at least one memory and the computer program code (software), are configured, with the at least one processor, to cause the apparatus to carry out any one of the above-described processes. The memory may be implemented using any suitable data storage technology, such as semiconductor-based memory devices, flash memory, magnetic memory devices and systems, optical memory devices and systems, fixed memory and removable memory. The memory may comprise a database for storing data.

In an embodiment, the apparatus 50 may be or be comprised in a network node, such as in gNB/gNB-CU/gNB-DU of 5G. In an embodiment, the apparatus is or is comprised in the network node 110. The apparatus may be caused to execute some of the functionalities of the above described processes, such as the steps of FIG. 4.

In an embodiment, a CU-DU (central unit-distributed unit) architecture is implemented. In such case the apparatus 50 may be comprised in a central unit (e.g. a control unit, an edge cloud server, a server) operatively coupled (e.g. via a wireless or wired network) to a distributed unit (e.g. a remote radio head/node). That is, the central unit (e.g. an edge cloud server) and the radio node may be standalone apparatuses communicating with each other via a radio path or via a wired connection. Alternatively, they may be in a same entity communicating via a wired connection, etc. The edge cloud or edge cloud server may serve a plurality of radio nodes or a radio access networks. In an embodiment, at least some of the described processes may be performed by the central unit. In another embodiment, the apparatus may be instead comprised in the distributed unit, and at least some of the described processes may be performed by the distributed unit. In an embodiment, the execution of at least some of the functionalities of the apparatus 50 may be shared between two physically separate devices (DU and CU) forming one operational entity. Therefore, the apparatus may be seen to depict the operational entity comprising one or more physically separate devices for executing at least some of the described processes. In an embodiment, the apparatus controls the execution of the processes, regardless of the location of the apparatus and regardless of where the processes/functions are carried out.

The apparatus may further comprise communication interface (TRX) 56 comprising hardware and/or software for realizing communication connectivity according to one or more communication protocols. The TRX may provide the apparatus with communication capabilities to access the radio access network, for example. The apparatus may also comprise a user interface 58 comprising, for example, at least one keypad, a microphone, a touch display, a display, a speaker, etc. The user interface may be used to control the apparatus by the user.

The control circuitry 52 may comprise a transmission scheduling circuitry 60 for determining and possibly modifying the transmission schedule of the transmissions of the apparatus, according to any of the embodiments. The control circuitry 52 may comprise a multicast broadcast service (MBS) circuitry 62 e.g. for providing broadcast services in the cell, according to any of the embodiments.

In an embodiment, an apparatus carrying out at least some of the embodiments described comprises at least one processor and at least one memory including a computer program code, wherein the at least one memory and the computer program code are configured, with the at least one processor, to cause the apparatus to carry out the functionalities according to any one of the embodiments described. According to an aspect, when the at least one processor executes the computer program code, the computer program code causes the apparatus to carry out the functionalities according to any one of the embodiments described. According to another embodiment, the apparatus carrying out at least some of the embodiments comprises the at least one processor and at least one memory including a computer program code, wherein the at least one processor and the computer program code perform at least some of the functionalities according to any one of the embodiments described. Accordingly, the at least one processor, the memory, and the computer program code form processing means for carrying out at least some of the embodiments described. According to yet another embodiment, the apparatus carrying out at least some of the embodiments comprises a circuitry including at least one processor and at least one memory including computer program code. When activated, the circuitry causes the apparatus to perform the at least some of the functionalities according to any one of the embodiments described.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry.

A term non-transitory, as used herein, is a limitation of the medium itself (i.e. tangible, not a signal) as opposed to a limitation on data storage persistency (e.g. RAM vs. ROM).

As used herein the term “means” is to be construed in singular form, i.e. referring to a single element, or in plural form, i.e. referring to a combination of single elements. Therefore, terminology “means for [performing A, B, C]”, is to be interpreted to cover an apparatus in which there is only one means for performing A, B and C, or where there are separate means for performing A, B and C, or partially or fully overlapping means for performing A, B, C. Further, terminology “means for performing A, means for performing B, means for performing C” is to be interpreted to cover an apparatus in which there is only one means for performing A, B and C, or where there are separate means for performing A, B and C, or partially or fully overlapping means for performing A, B, C.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g, procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments as described may also be carried out in the form of a computer process defined by a computer program or portions thereof. Embodiments of the methods described may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Following is a list of some aspects of the invention.

According to a first aspect, there is provided a method at an apparatus, comprising: receiving information of transmission schedule from a second cell, wherein the apparatus is capable of receiving from one cell at a time; determining, based on the received transmission schedule, that transmissions from the second cell cannot be received within limits set by a gap configuration of a first cell, wherein the apparatus is in radio resource control (RRC) connected state with respect to the first cell; transmitting to the second cell an indication that the transmissions from the second cell cannot be received based on the transmission schedule; and receiving information of a modified transmission schedule from the second cell.

Various embodiments of the first aspect may comprise at least one feature from the following bulleted list:
wherein the information of the transmission schedule is received via a broadcast transmission from the second cell while the apparatus is in RRC IDLE state or in RRC INACTIVE state with respect to the second cell.
wherein the information of the transmission schedule is comprised in at least one of system information block 20 or multicast broadcast service control channel.
wherein the transmission schedule indicates a schedule of broadcast transmissions, and comprises at least one of periodicity, transmission length, or modification length of transmitted control channel information of the broadcast transmission.
wherein the gap configuration indicates scheduling gaps of the first cell during which the apparatus can monitor for transmissions of another cell.
wherein determining that the transmission from the second cell cannot be received within limits set by the gap configuration of the first cell comprises determining that a transmission monitoring window for the transmissions of the second cell is larger than maximum available gap of the first cell.
wherein the reception of the information of the transmission schedule triggers the apparatus to: request for the gap configuration from the first cell, and based on requesting the gap configuration, receive the gap configuration from the first cell.
wherein transmitting the indication to the second cell comprises including the indication in small data transmission during a gap of the first cell without establishing RRC connection with the second cell.
wherein the reception of the information of the transmission schedule triggers the apparatus to: request, from the first cell, to leave the RRC connection in the first cell and to receive an RRC release message from first cell, wherein the request comprises a preference to move to an RRC_IDLE or an RRC_INACTIVE state after leaving the RRC connection in the first cell; and one of: receive the RRC release message from the first cell, or move to the RRC idle in the first cell after waiting a predetermined time without receiving the RRC release message from the first cell.
wherein transmitting the indication to the second cell comprises temporarily entering RRC CONNECTED state with respect to the second cell; and transmitting the indication in the RRC CONNECTED state.
wherein, when entering the RRC connected state with respect to the second cell, entering RRC inactive state or RRC idle state with respect to the first cell; and resuming or re-establishing RRC connected state with respect to the first cell after the apparatus has transmitted the indication to the second cell.
wherein entering the RRC connected state with respect to the second cell takes place within a gap of the first cell without leaving the RRC connected state with respect to the first cell.
wherein transmitting the indication to the second cell comprises transmitting information of the available gap configuration of the first cell.
wherein transmitting the indication to the second cell comprises transmitting at least one of the following: the maximum gap duration that the apparatus can request from the first cell or the maximum transmission monitoring window that the apparatus can tolerate from the second cell, and wherein the modification of the transmission schedule is based on the gap configuration of the first cell or the maximum transmission monitoring window that the apparatus can tolerate from the second cell.
wherein the apparatus comprises multi subscriber identity modules (MUSIM).
wherein the apparatus is a user equipment.

According to a second aspect, there is provided a method at an apparatus, comprising: broadcasting a transmission schedule of a second cell; receiving from a user equipment in the second cell an indication that transmissions of the second cell cannot be received based on the current transmission schedule, wherein the user equipment is capable of receiving from one cell at a time; modifying the transmission schedule based on the received indication; and broadcasting a modified transmission schedule of the second cell.

Various embodiments of the second aspect may comprise at least one feature from the following bulleted list:
wherein the information of the transmission schedule is transmitted via a broadcast transmission.
wherein the information of the transmission schedule is comprised in at least one of system information block 20 or multicast broadcast service control channel.
wherein the transmission schedule indicates a broadcast transmission schedule of the second cell, and comprises at least one of periodicity, transmission length, or modification length of transmitted control channel information of the broadcast transmission.
wherein the indication comprises information of the gap configuration of a first cell, wherein the gap configuration defines scheduling gaps of the first cell during which the user equipment can monitor for transmissions of another cell.
wherein the indication comprises information of at least one of the following: the maximum gap duration that the user equipment can request from the first cell or the maximum transmission monitoring window that the user equipment can tolerate from the second cell.
wherein modifying the transmission schedule based on the received indication comprises reducing the maximum transmission monitoring window associated with the transmissions of the transmission schedule.
wherein modifying the transmission schedule based on the received indication comprises increasing the repetition frequency associated with the transmissions of the transmission schedule.
wherein modifying the transmission schedule based on the received indication comprises partitioning the transmissions of the transmission schedule.
wherein transmitting the modified transmission schedule of the second cell comprises transmitting different transmission schedules for different partitions of the transmissions.
wherein modifying the transmission schedule based on the received indication comprises rearranging the content of the transmissions of the transmission schedule such that predetermined type of content is transmitted in the beginning of a respective transmission window.
receiving a plurality of indications from a plurality of user equipments; and modifying the transmission schedule based on the received plurality of indications.

According to a third aspect, there is provided an apparatus, comprising: at least one processor; and at least one memory storing instructions that, when executed by the at least one processor, cause the apparatus at least to: receive information of transmission schedule from a second cell, wherein the apparatus is capable of receiving from one cell at a time; determine, based on the received transmission schedule, that transmissions from the second cell cannot be received within limits set by a gap configuration of a first cell, wherein the apparatus is in radio resource control (RRC) connected state with respect to the first cell; transmit to the second cell an indication that the transmissions from the second cell cannot be received based on the transmission schedule; and receive information of a modified transmission schedule from the second cell. Various embodiments of the third aspect may comprise at least one feature from the bulleted list under the first aspect.

According to a fourth aspect, there is provided an apparatus, comprising: at least one processor; and at least one memory storing instructions that, when executed by the at least one processor, cause the apparatus at least to: broadcast a transmission schedule of a second cell; receive from a user equipment in the second cell an indication that transmissions of the second cell cannot be received based on the current transmission schedule, wherein the user equipment is capable of receiving from one cell at a time; modify the transmission schedule based on the received indication; and broadcast a modified transmission schedule of the second cell. Various embodiments of the fourth aspect may comprise at least one feature from the bulleted list under the second aspect.

According to a fifth aspect, there is provided a computer program product embodied on a distribution medium readable by a computer and comprising program instructions which, when loaded into an apparatus, execute the method according to the first aspect.

According to a sixth aspect, there is provided a computer program product embodied on a distribution medium readable by a computer and comprising program instructions which, when loaded into an apparatus, execute the method according to the second aspect.

According to a seventh aspect, there is provided a computer program product comprising program instructions which, when loaded into an apparatus, execute the method according to the first aspect.

According to an eight aspect, there is provided a computer program product comprising program instructions which, when loaded into an apparatus, execute the method according to the second aspect.

According to a ninth aspect, there is provided an apparatus, comprising means for performing the method according to the first aspect, and/or means configured to cause the apparatus to perform the method according to the first aspect.

According to a tenth aspect, there is provided an apparatus, comprising means for performing the method according to the second aspect, and/or means configured to cause the apparatus to perform the method according to the second aspect.

According to an eleventh aspect, there is provided computer implemented system, comprising: a server and at least one radio node; and at least one processor and at least one memory storing instructions that, when executed by the at least one processor, cause the system at least to carry out the method according to the first aspect and/or the method according to the second aspect.

According to a twelfth aspect, there is provided computer implemented system, comprising: one or more processors; at least one data storage, and one or more computer program instructions to be executed by the one or more processors in association with the at least one data storage for carrying out the method according to the first aspect and/or the method according to the second aspect.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus, comprising:
at least one processor; and
at least one memory storing instructions that, when executed by the at least one processor, cause the apparatus at least to:
receive information of transmission schedule from a second cell, wherein the apparatus is capable of receiving from one cell at a time;
determine, based on the received transmission schedule, that transmissions from the second cell cannot be received within limits set by a gap configuration of a first cell, wherein the apparatus is in radio resource control (RRC) connected state with respect to the first cell;
transmit to the second cell an indication that the transmissions from the second cell cannot be received based on the transmission schedule; and
receive information of a modified transmission schedule from the second cell.

2.-33. (canceled)
